(19) United States
(12) Patent Application Publication
(10) Pub. No.: US 2013/0188624 A1
(43) Pub. Date: Jul. 25, 2013

(54) APPARATUS AND METHOD FOR SEARCHING NEIGHBOR CELLS OF SMALL CELL BASE STATION

(71) Applicant: Jung Seung LEE, Uiwang-si (KR)

(72) Inventor: Jung Seung LEE, Uiwang-si (KR)

(21) Appl. No.: 13/354,687

(22) Filed: Jan. 20, 2012

(51) Int. Cl. H04W 74/04; H04W 72/04

(52) U.S. Cl. 370/338

(57) ABSTRACT

When a first synchronization signals are measured to search neighbor cells, at least one of (i) a mute control of a second synchronization signal of the small cell base station and transmission of the second synchronization signal with the mute control to a downlink, and (ii) a downlink scheduling restriction of PDSCH data is performed. When PBCH information is acquired to search neighbor cells having the same frequency, PDSCH data are not transmitted to designated RBs of a downlink subframe by restricting downlink scheduling. At this time, when acquiring PDSCH and PDCCH information and measuring RSRP and RSRQ, it is possible not to transmit the PDSCH data to all the RBs of a downlink subframe by restricting downlink scheduling. In this way, muting and scheduling during downlink transmission can be controlled by measuring the amount of interference of the small cell base station.

### TECHNICAL FIELD

The present disclosure generally relates to a mobile communication system, and more particularly to an apparatus and a method capable of acquiring information on neighbor cells of a small cell base station through a downlink receiving function in small cell base station, in order to implement a self-organizing network (SON) in the small cell base station which adopts technologies such as long term evolution (LTE) and long term evolution-advanced (LTE-A).

### BACKGROUND

With rapid developments in communications, computer networks and semiconductor technologies, a variety of services are provided using wireless communication networks. Not only that, users are requiring higher-level services and wireless internet service market around the world is growing explosively. To accommodate these trends, a mobile communication system using a wireless communication network is being evolved to provide a multimedia communication service transmitting various data in addition to a voice service.

Recently, wireless data services through code division multiple access (CDMA) 2000, evolution data only (EV-DO), wideband CDMA (WCDMA) and wireless local area networks (WLANs) have been commercialized. Thus, the residential use of mobile phones and the demand for mobile data at home have increased steadily. To keep up with such trend, a method for providing mobile communication services by installing a small cell base station indoors has been proposed so as to access a core network of the mobile communication system through an indoor broadband network. Particularly in a next-generation network system, a method of disposing a number of small size cells (e.g., femtocells) has been proposed to meet the demand for a high data transmission rate and facilitate stable and reliable providing of various services. A small cell base station covering such small size cells may otherwise be referred to as an indoor base station or a femto base station and a Home-eNB, a HeNB or the like in the 3rd Generation Partnership Project (3GPP). As such, by reducing the size of the cell to be served in an indoor environment, efficiency of the next-generation network system using a high frequency band can be improved. Further, using a number of small size cells is advantageous in that the number of times of frequency reuse can be increased. Also, such a small size multiple cell using scheme offers an advantage of improving the deteriorated channel status due to radio wave attenuation which is caused by controlling the entire cell area with only one base station. The scheme also offers the advantage of enabling services to a user in a shadow area, which used to be impossible. Based on these advantages, a scheme of combining a conventional macrocell (a cell area controlled by an outdoor base station) and a femtocell (a cell area controlled by a small cell base station such as an indoor base station, a femto base station and the like) is newly devised and is drawing attention.

The above-described cell combining scheme has advantage in light of the provision of service. Such a scheme, however, has disadvantage in that it requires a larger number of base stations to provide high quality data service in the same area to thereby increase costs in installation and operation of the base stations. In particular, a lot of labor and time are required to determine a parameter in relation with radio or cable characteristics. Further, merely with a centralized management, it is difficult to efficiently cope with constant environmental changes. Furthermore, when changes are made, a redefinition with respect to the whole system should be given. Thus, it is not easy to detect optimum conditions with respect to a variable location of the base station (that is, the small cell base station is installed by a user where he/she wants, not at the optimum location designated by a service provider) and constantly changing wireless environments. These circumstances necessitate devising a self-organizing network (SON) designed to adapt to the wireless environments, where the base stations and networks are randomly installed and also automatically change, and data traffic environments. For implementation of the SON, measurement of wireless information and surrounding network information are needed. Accurate and abundant input information facilitates implementation of effective SON algorithm.

Ordinarily, installation of a base station accompanies the following procedures: to obtain the location of the base station, estimate radio wave propagation environments, then predict neighbor cells to which a user equipment can perform a handover, and thereby make a neighbor cell list (NCL). The NCL broadcasted by the base station refers to information which indicates configurations of the neighbor cells when the user equipment serviced by the serving base station performs the handover to one of the neighbor cells. The base station broadcasts the NCL and the user equipment to perform the handover to another cell performs neighbor cell search by using the broadcasted NCL.

As described above, to cope with the mobile communications market trend that requires small cell coverage, a larger number of base stations are necessary to provide high quality data services in the same area. Installation and maintenance of a large number of base stations entails enormous costs for network installation and maintenance. Particularly in case of the small cell base station such as the indoor base station, the femto base station and the like, it is expected that a much larger number of base stations would be installed. Furthermore, power on/offs of the base stations would be freely performed. Mobility of the base stations should also be ensured. Under these circumstances, implementation of a SON function is desperately needed, which allows each base station to access a network and perform setting, on its own, when it is installed indoors or outdoors and also has functions of properly optimizing and operating each cell according to the surrounding wireless environments. The SON enables a network service provider to automatically operate the network which has been manually controlled. That is, the SON function means that each base station automatically sets and optimizes values on its own in the network.

Though the SON function is necessary for every base station for installation and optimization thereof, it is more necessary for a small cell base station which is installed by the user personally. Specifically, the small cell base station needs to have an enhanced SON function for convenient installation thereof when the user purchases and installs the small cell base station in his/her home or when the user changes the location of the small cell base station due to the user's move out or the like. For implementation of the enhanced SON function in the small cell base station, the small cell base station needs to be equipped with a sniffer function (or sniffer apparatus), a function of receiving signals from neighbor base stations. The sniffer function allows the base station to perform a cell search operation as done in a user equipment. In a time division duplex (TDD) mode, the base station receives during the transmission time thereof. In a frequency division duplex (FDD) mode, the base station receives on the same frequency that is used in transmission. When the small cell base station is turned on and connected to a wired network, the small cell base station receives signals from the neighbor base stations by using the sniffer function (or apparatus) to thereby measure the wireless environments (e.g., received signal strengths of the neighbor base stations, etc.) and receive broadcast information. Based on these, the SON may set parameters of the base station device (e.g., transmit power of the base station) through its own algorithm. Once setting of all parameters is completed, communications with the user equipment is initiated. Even in the middle of the communications with the user equipment, the small cell base station can receive the signals from the neighbor base stations by using the sniffer function (or apparatus) and optimize its own parameters through the SON,

As such, the sniffer function (or apparatus) for searching the neighbor cells is necessary to effectively implement the SON function in the small cell base station. The more accurate and various information the sniffer function (or apparatus) obtains, the more accurate result the SON produces. The sniffer function means that a downlink receiving function of the user equipment is identically implemented in the base station. Specifically, the base station receives the downlinks of the neighbor base stations through the sniffer function (or apparatus) and analyzes them. However, since the small cell base stations are mostly installed indoors, interference caused by its own downlink (i.e., self-interference (SI)) may considerably affect a receiver having the sniffer function (i.e., downlink receiver), as shown in FIG. 1. The SI indicates interference occurring to a reception antenna by signals of a transmission antenna when the transmission antenna and the reception antenna transmits and receives the signals, respectively, during the same time period and in the same band. In other words, a reflected wave reflected by the wall and a radiation pattern of the downlink directly affect the receiver with the sniffer function (i.e., downlink receiver) and thus they are considered as hindering factors to neighbor cell search. Therefore, when the small cell base station performs the transmission and the sniffer function (or apparatus) at the same time (i.e., performs the downlink transmitting and receiving functions at the same time), there is a high possibility that the small cell base station may select the wrong cell.

However, if the small cell base station does not perform downlink transmission during a certain period of time to decrease the SI signals, a call drop may occur in the user equipment. To avoid interference by the user equipments, the sniffer function (or apparatus) may be operated only for the neighbor cells where user equipments using small cell base stations do not exist or are in an idle state (the reason is that, without the user equipments or only with the user equipments in the idle state, downlink powers of the neighbor cells decrease and thus the receiver with the sniffer function of the small cell base station can search the neighbor cells without being affected by interference.) In this case, however, only limited neighbor cell search will be performed since the sniffer function (or apparatus) operates only for the neighbor cells with no user equipments connected thereto or with user equipments in the idle state, as described above. Under these circumstances, a new method is greatly and urgently needed that is capable of measuring the neighbor cells freely by the sniffer function (or apparatus) without affecting the downlink of the small cell base station.

### SUMMARY

The present disclosure provides some embodiments of an apparatus and a method capable of minimizing SI in acquiring information on neighbor cells by using a downlink receiving function of a small cell base station in order to implement a SON in the small cell base station which adopts technologies such as LTE and LTE-A.

In accordance with an aspect of the present disclosure, a neighbor cell searching apparatus and method of a small cell base station capable of minimizing self-interference and a mobile communication system therefor are disclosed. According to one embodiment, when a first synchronization signals are measured to search neighbor cells, at least one of (i) a mute control of a second synchronization signal of the small cell base station and transmission of the second synchronization signal with the mute control to a downlink, and (ii) a downlink scheduling restriction of physical downlink shared channel (PDSCH) data is performed. According to another embodiment, when physical broadcast channel (PBCH) information is acquired to search neighbor cells having the same frequency, PDSCH data are not transmitted to designated resource blocs (RBs) of a downlink subframe by restricting downlink scheduling. At this time, when acquiring PDSCH and physical downlink control channel (PDCCH) information and measuring reference signal received power (RSRP) and reference signal received quality (RSRQ), it is possible not to transmit the PDSCH data to all the RBs of a downlink subframe by restricting downlink scheduling.

In the above, the self interference of a small cell base station may be measured to control the muting and scheduling in a downlink transmission.

### BRIEF DESCRIPTION OF THE DRAWINGS

FIG. 1 is a diagram showing occurrence of self-interference (SI) in a small cell base station.

FIG. 2 is a diagram showing an illustrative embodiment of a mobile communication network.

FIG. 3 illustrates a relationship between a primary synchronization signal (PSS) and a secondary synchronization signal (SSS) in each of a time domain and a frequency domain in a LTE downlink frame structure.

FIG. 4 illustrates channel mapping of broadcast information.

FIG. 5 is a schematic block diagram showing an illustrative embodiment of small cell base station for canceling downlink SI.

FIG. 6 is a detailed block diagram showing an illustrative embodiment of a downlink transmitter and a downlink receiver.

FIG. 7 is a flow chart showing a procedure of searching neighbor cells of a small cell base station in accordance with the present embodiment.

FIG. 8 illustrates mapping of a constant amplitude zero auto correlation (CAZAC) code and a timing relation between a transmission signal and a received signal.

FIG. 9 illustrates a mute control process and a scheduling control (restriction) process in accordance with the present embodiment.

FIG. 10 illustrates mapping of a reference signal (RS) with respect to a normal cyclic prefix (CP).

### DETAILED DESCRIPTION

Hereinafter, embodiments of the present invention will now be described in detail with reference to accompanying drawings. In the following, detailed descriptions of well-known functions and constructions will be omitted to avoid obscuring the essence of the present disclosure.

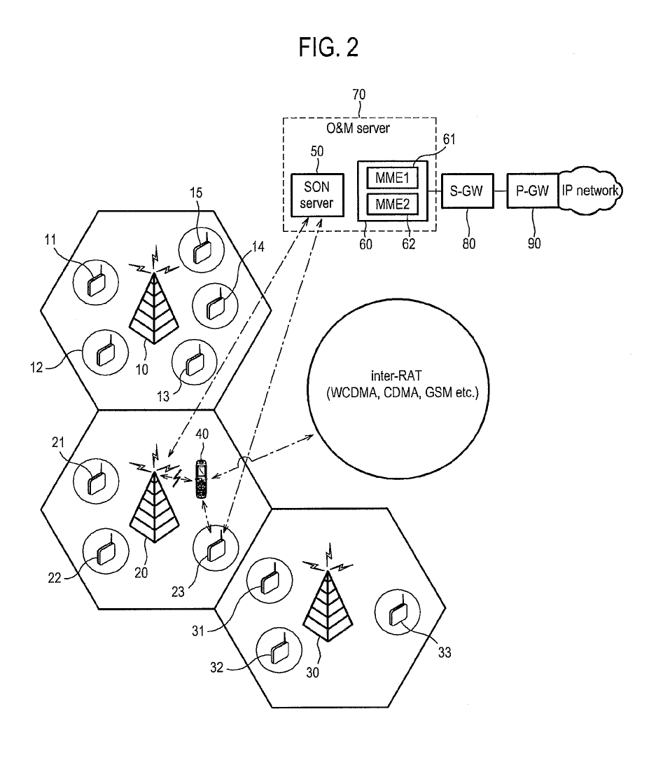

FIG. 2 is a diagram showing an illustrative embodiment of a mobile communication network.

In one embodiment, a mobile communication network may include a 2G mobile communication network such as global system for mobile communication (GSM) and code division multiple access (CDMA), a mobile communication network for supporting wireless internet such as long term evolution (LTE) and wireless fidelity (WiFi), portable internet such as wireless broadband internet (WiBro) and world Interoperability for microwave access (WiMax) and packet transfer (for example, a 3G mobile communication network such as wideband CDMA (WCDMA) and CDMA 2000, a 3.5G mobile communication network such as high speed downlink packet access (HSDPA) and high speed uplink packet access (HSUPA), a 4G mobile communication network currently being serviced, and the like), and other types of mobile communication networks including a macro base station (e.g., macro-eNB), a small cell base station (e.g., femto base station or home-eNB (HeNB)) and a user equipment UE. However, the mobile communication network may not be limited thereto. The present embodiment is described mainly in the context of an evolved UMTS terrestrial radio access network (e-UTRAN) which is a wireless access network of LTE.

As shown in FIG. 2, the mobile communication network may be configured with one or more network cells. Different types of network cells may be in a mixed form in the mobile communication network. The mobile communication network may include small cell base stations (Home-eNBs) 11 to 15, 21 to 23 and 31 to 33 covering small size network cells (e.g., femtocells), macro base stations (Macro-eNBs or eNBs) 10, 20 and 30 covering large size cells (e.g., macrocells), a user equipment UE 40, a self-organizing & optimizing network (SON) server 50, a mobile mobility entity (MME) 60, a serving gateway (S-GW) 80 and a packet data network gateway (P-GW) 90. The number of each component depicted in FIG. 2 is merely exemplary and is not limited to those in the drawings.

The macro base stations (Macro-eNBs) 10, 20 and 30 may have features of, for example, a macrocell base station covering a cell with the radius of approximately 1 km, which may be used in, for example, a LTE network, a WiFi network, a WiBro network, a WiMax network, a WCDMA network, a CDMA network, a UMTS network, a GSM network and the like. However, the macro base stations (Macro-eNBs) 10, 20 and 30 may not be limited thereto.

The small cell base stations (Home-eNBs) 11 to 15, 21 to 23 and 31 to 33 may have features of, for example, an indoor base station or a femto base station covering a cell with the radius of several tens of meters, which may be used in, for example, a LTE network, a WiFi network, a WiBro network, a WiMax network, a WCDMA network, a CDMA network, a UMTS network, a GSM network and the like. However, the small cell base stations (Home-eNBs) 11 to 15, 21 to 23 and 31 to 33 may not be limited thereto.

Each of the macro base stations 10, 20 and 30 and the small cell base stations 11 to 15, 21 to 23 and 31 to 33 may have independent accessibility to a core network.

The UE 40 may have features of a wireless mobile terminal used in a 2G mobile communication network such as a GSM network and a CDMA network, a wireless internet network such as a LTE network and a WiFi network, a portable internet network such as a WiBro network and a WiMax network and a mobile communication network supporting packet transfer. However, the UE 40 may not be limited thereto.

An operation and maintenance (O & M) server 70, serving as a network management apparatus of the small cell base station, may perform management of the small cell base station 11 to 15, 21 to 23 or 31 to 33 and the macro base stations 10, 20 and 30 and configuration information thereof. The O & M server 70 may have functions of both the SON server 50 and the MME 60. The SON server 50 may perform installation and optimization of the macro base stations and small cell base stations and include a server configured to provide basic parameters and/or data necessary for each base station. The MME 60 may include an arbitrary entity for managing mobility of the UE 40. MMEs 61 and 62, functioning as a base station controller (BSC), may perform resource allocation, call control, handover control, voice and packet processing and the like for the base stations (HeNB, Macro-eNB, etc.) connected thereto.

In one embodiment, the one O & M server 70 may have functions of both the SON server 50 and the MME 60. The SON server 50 and the MME 60 may manage one or more macro base stations 10, 20 and 30 and one or more small cell base stations 11 to 15, 21 to 23 and 31 to 33.

In the above-described mobile communication network, it is assumed that the network cells are in the mixed form of the macrocells and femtocells. However, the network cells may be configured with a single type of cells, i.e., with either macrocells or femtocells.

Assuming that the above-described mobile communication network is a LTE network, the LTE network may interwork with an inter-RAT network (such as WiFi network, WiBro network, WiMax network, WCDMA network, CDMA network, UMTS network, GSM network and the like). If one type of inter-RAT network (e.g., the WiBro network) is implemented as the above-described mobile communication network, the WiBro network may also interwork with the other types of networks (LTE network, WiFi network, WiMax network, WCDMA network, CDMA network, UMTS network, GSM network and the like). In the drawing, one type of network (e.g., LTE network) is separated from the other types of networks (WiFi network, WiBro network, WiMax network, WCDMA network, CDMA network, UMTS network, GSM network and the like). However, the present embodiment is based on the premise that one type of network and the other types of networks are overlaid with each other.

When the UE 40 performs a handover from the serving base station to one of the neighbor cells (macrocell or femtocell), a neighbor cell list (NCL) broadcasted by the serving base station (one of the macro base stations 10, 20 and 30 and the small cell base stations 11 to 15, 21 to 23 and 31 to 33) may provide the UE 40 with information on configurations of the neighbor cells. For example, in the LTE network having 504 physical layer cell IDs (PCIs), the NCL may provide the UE 40 with information on the PCIs of the neighbor cells out of the 504 PCIs, thus allowing the UE 40 to efficiently perform the cell searching for handover. The NCL information may be divided into three groups according to the configuration of each neighbor cell, as follows: an intro-frequency NCL (including the neighbor cells which use the identical frequency with each other), an inter-frequency NCL (including the neighbor cells which use different frequencies from each other) and an inter-RAT NCL (including the neighbor cells which are respectively under different communication protocols from each other). The UE 40 searches the neighbor cells based on the NCL information and performs the handover to one of the neighbor macrocells and femtocells.

In the LTE network, the access to the macrocell may be allowed for all the UEs but the access to the femtocell may be allowed for a limited group of UEs (subscribers). Hereinafter, description will be made with the small cell base station 21 and such description is applied identically to the other small cell base stations 11 to 15, 22 to 23 and 31 and 33 having the same configurations as the small cell base station 21. The small cell base station 21 may broadcast a system information block type 1 (SIB 1), which is information on the femtocell controlled by the small cell base station 21. The SIB 1 may include a closed subscriber group (CSG) indicator which indicates whether the access to the femtocell is restricted or not. If the CSG indicator in the SIB 1 broadcasted by the small cell base station 21 has a value of “True,” the communications may be established in a closed mode, in which only a specific group of subscribers (i.e., closed subscriber group (CSG)) are allowed to access the femtocell. On the other hands, if the CSG indicator has a value of “False,” the communications may be established in an open mode, in which any subscriber (i.e., opened subscriber group (OSG)) is allowed to access the femtocell. When the CSG indicator has the “True” value, the UE 40 may check whether the femtocell is included in a white list, a list of femtocells that allow the access of the UE 40. The UE 40 can access the femtocell, only if the inclusion of the femtocell in the white list is confirmed.

For example, an access procedure of the UE 40 to the small cell base station 21 will be described below. Based on the CSG indicator in the SIB 1 broadcasted by the small cell base station 21, the UE 40 can figure out whether an access to the femtocell of the small cell base station 21 is restricted or not. There are two kinds of identifiers for the UE 40 to identify the cell of each small cell base station. One is a physical layer cell identity (PCI), a cell identifier in a physical layer. The other is a global cell identity (GCI), a unique cell identifier in the mobile communication network. The cell identifier is included in the SIB 1 broadcasted by the small cell base station 21. In one embodiment, if the UE 40 detects the accessible base station 21, then the UE 40 may report the detection to the macro base station 20. The macro base station 20 received the report of the detection of the small cell base station 21 from the UE 40 may instruct the UE 40 to read the SIB 1 received from the small cell base station 21 and report the cell identifier (PCI or GCI) of the small cell base station 21. Thereafter, the macro base station 20 may determine whether the detected small cell base station 21 is accessible to the UE 40, based on the cell identifier figured out by reading the SIB 1 by the UE 40 and the white list. If the macro base station 20 determines that the detected small cell base station 21 is accessible to the UE 40, the UE 40 is allowed to perform the handover to the small cell base station 21.

The above-described process may be applied in the case where the UE 40 accesses the macro base station 20 or another small cell base station from the small cell base station 21.

The present embodiment provides an interference avoiding method capable of minimizing self-interference (SI) affecting a sniffer function in the small cell base station 21 by cutting off its own downlink signal and executing restricted scheduling while performing the sniffer function, thereby allowing the small cell base station 21 to efficiently acquire information on the neighbor cells. The above is also applied to the small cell base stations 11 to 15, 22 to 23 and 31 to 33.

In the LTE system, there exist as many as 504 physical layer cell IDs (PCIs). The 504 PCIs are divided into 168 PCI groups, each of which consists of three IDs (see equation 1).

N_{ID}^{cell}=3N_{ID}⁽¹⁾+N_{ID}⁽²⁾ Eq. 1

wherein N_{ID}⁽¹⁾ is composed of a primary synchronization signal (PSS) having a value within the range from 0 to 167 and N_{ID}⁽²⁾ is composed of a secondary synchronization signal (SSS) having a value within the range from 0 to 2.

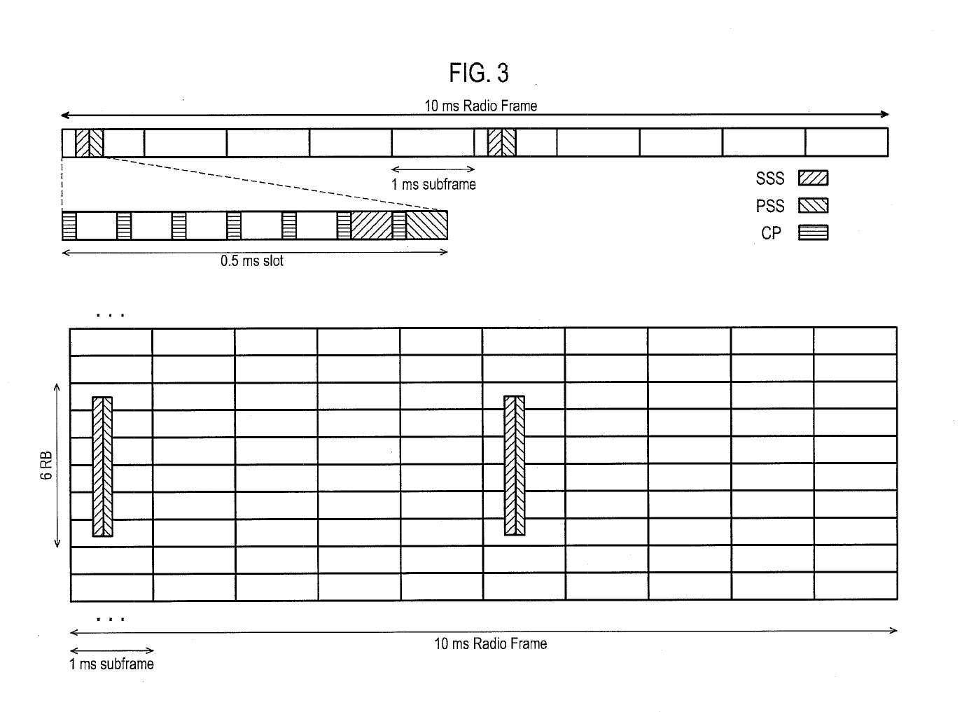

FIG. 3 illustrates a relationship between the PSS and SSS in each of a time domain and a frequency domain in the LTE downlink (DL) frame structure.

In the LTE DL frame structure, a minimum transmission unit is a transmission time interval (TTI). One TTI (i.e., subframe) is composed of two consecutive slots (in other words, an even-numbered slot and an odd-numbered slot constitutes one TTI). Each slot may be composed of fifty resource blocks (RB) in the bandwidth of, for example, 10 MHz and each RB may be composed of, for example, seven symbols (I=0, 1, . . . 6) along a time axis and twelve subcarriers along a frequency axis. In this case, each RB is composed of eighty four (7×12=84) resource elements (RE). The DL data transmission from the base station to the UE 40 may be performed in the unit of RB. In the LTE DL frame structure, the DL data transmission may be performed through a physical downlink shared channel (PDSCH). The DL control information transmission may be performed through a physical downlink control channel (PDCCH), a physical control format indicator channel (PCFICH) and a physical hybrid ARQ indicator channel (PHICH). The DL synchronization signal (channel) may include the PSS and the SSS. A reference signal (RS) may serve as a signal for coherent detection and measurement of the DL data and the DL control information.

The DL synchronization signal is periodically transmitted to a radio frame so that a random UE 40 can perform cell search at any time. Further, the DL synchronization signal may occupy six RBs at the center of the frequency domain (twelve subcarriers constitutes one RB) to use the minimum bandwidth used in the LTE system. This allows even the UE 40 incapable of supporting a wide bandwidth to conduct cell search.

In the present embodiment, in order to perform such cell search function of the UE 40 in the small cell base station 21, a downlink receiver is added to a sniffer apparatus of the small cell base station 21 to thereby acquire information on the neighbor cells. In other words, by implementing a downlink receiving function of the UE 40 in the sniffer apparatus of the small cell base station 21, the small cell base station 21 can search the neighbor cells by using the sniffer apparatus.

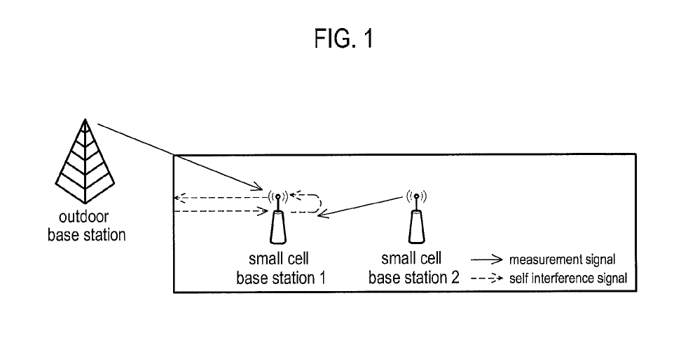

However, since the small cell base station 21 is installed indoors in most cases, interference by a wall or other factors may act as downlink interference (i.e., self-interference (SI)) of the sniffer apparatus (see FIG. 1).

The small cell base station 21 may acquire information on the neighbor cells by means of the sniffer apparatus. The information on the neighbor cells to be acquired by the sniffer apparatus may include the PCI, slot synchronization acquisition, cyclic prefix (CP), frame synchronization acquisition, system information acquisition, measurement of reference signal received power (RSRP)/reference signal received quality (RSRQ), broadcast information and the like. To acquire some of the broadcast information, decoding of the PDCCH (which includes scheduling information and the like) may be required. If the small cell base station and the neighbor cell thereof operate in the same frequency band, chances are that the measurement in the sniffer apparatus would be inaccurate due to the SI, as described above. However, in the state that the UE 40 is connected to the small cell base station 21, minimization of influence to the UE 40 (e.g., call drop) and maximization of measurement efficiency of the sniffer apparatus can be achieved by partial downlink muting and scheduling control, as in the present embodiment.

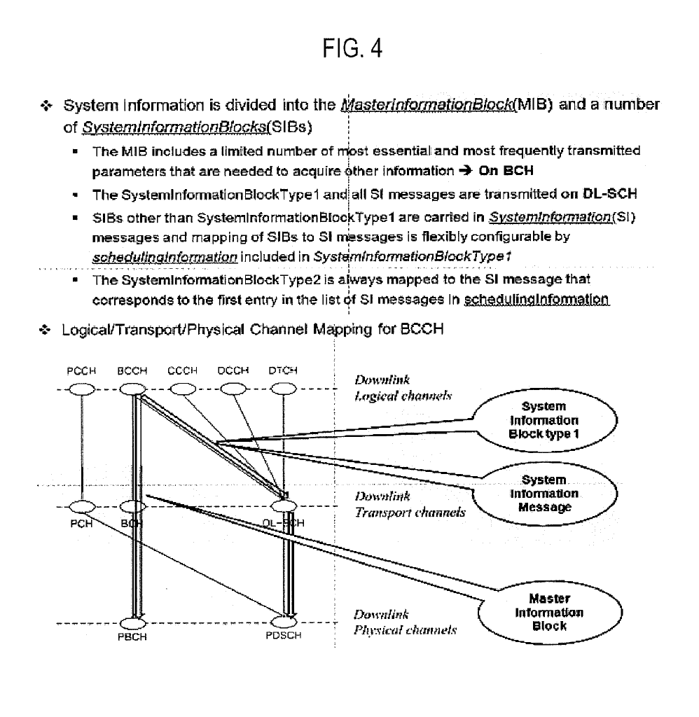

The broadcast information is composed of a master information block (MIB) and a system information blocks (SIB) and channel mapping therefor is as shown in FIG. 4. The MIB includes paging information and information on the bandwidth and a single frequency network (SFN) and is acquired by decoding a physical broadcast channel (PBCH) through which the MIB is provided. The SIB is transmitted via a DL-SCH (PDSCH) and, thus, a scheduler is involved in the SIB transmission as in ordinary data transmission. Therefore, to figure out which radio resource is used in the SIB transmission, the PDCCH information should be available to acquire the SIB broadcast information. The PBCH bandwidth information and the SFN information included in the broadcast information are needed to acquire the broadcast information transmitted through the PDSCH. The bandwidth information included in the broadcast information is needed to measure the RSRP and RSRQ. The GCI information included in the SIB is needed to identify the neighbor cells (the GCIs are unique within the public lands mobile network (PLMN)). This is because, since duplicate PCIs may be assigned within the network due to the limited number of the PCIs of 504, the cells cannot be identified by the PCIs.

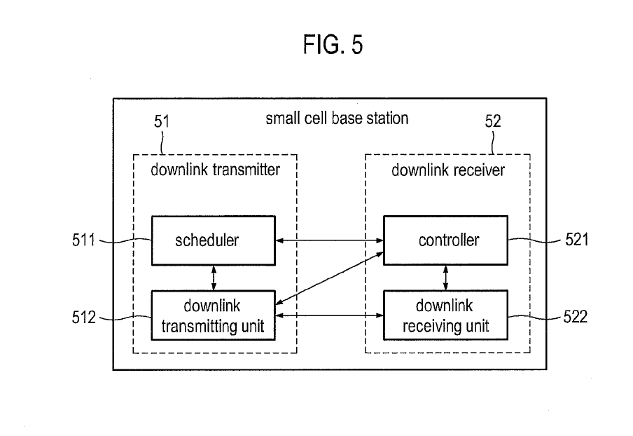

FIG. 5 is a schematic diagram showing a configuration of the small cell base station for canceling downlink SI in accordance with the present embodiment.

The small cell base stations 21 may include a downlink transmitter 51 and a downlink receiver 52. The downlink transmitter 51 may include a scheduler 511 and a downlink transmitting unit 512. The downlink receiver 52 may include a controller 521 and a downlink receiving unit 522.

The downlink receiver (i.e., sniffer apparatus) 52 may search the neighbor cells basically by performing the sniffer function. At this time, particularly the controller 521 may receive the transmitted signals from the downlink transmitting unit 512 via the downlink receiving unit 522 and check how much SI exists. Depending on the result of the check, either a mute control or a restricted scheduling may be performed to minimize the SI affecting the sniffer function. The mute control is performed by making the downlink transmitting unit 512 cut off the downlink signals and then perform transmission. The restricted scheduling is performed by controlling the scheduler 52. As an example of the mute control, when the synchronization signals are measured to search the neighbor cells, powers of the synchronization signals (PSS and SSS) allocated to the central six RBs are muted to be “zero” and then synchronization signals with zero power are transmitted. As an example of the restricted scheduling, when the synchronization signals are measured to search the neighbor cells, the PDSCH data are allocated to the data channels of the forty four RBs, not to the central six RBs, or, alternatively, the PDSCH data allocation process may be omitted. As another example of the restricted scheduling, when the PBCH is decoded for acquisition of the RSRP/RSRQ information and the broadcast information to search the neighbor cells, the PDSCH data are not transmitted to the central six RBs.

Herein, the central six RBs are the resource blocks in which the synchronization signals and the PDSCH are transmitted.

Before performing the mute control and the scheduling control, the SI is compared with a threshold. If the SI exceeds the threshold, the mute control and the scheduling control are performed. However, it is to be noted that those controls can be performed unconditionally, skipping such comparison process.

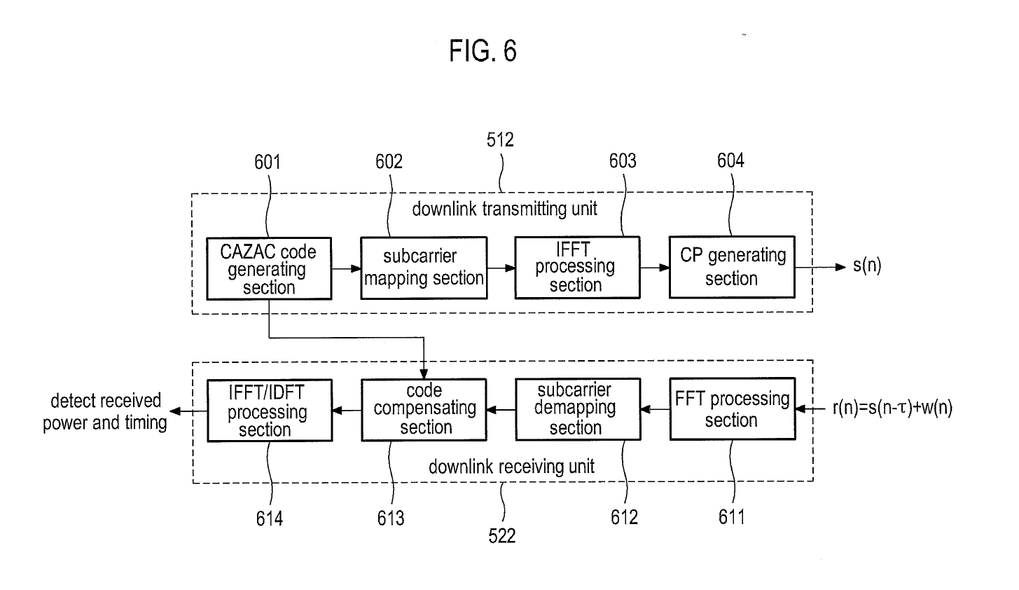

As shown in FIG. 6, the downlink transmitting unit 512 may include a constant amplitude zero auto correlation (CAZAC) code generating section 601, a subcarrier mapping section 602, an inverse fast Fourier transform (IFFT) processing section 603 to perform an IFFT, and a cyclic prefix (CP) generating section 604. The downlink receiving unit 522 may include a fast Fourier transform (FFT) processing section 611, a subcarrier demapping section 612, a code compensating section 613, and an inverse fast Fourier transform/inverse discrete Fourier transform (IFFT/IDFT) processing section 614. Operation of each component will be described in detail later.

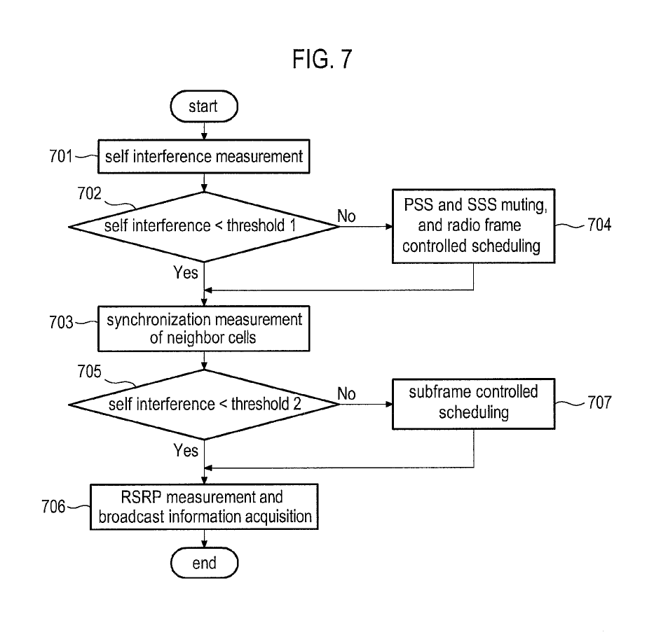

In the following, a process of searching the neighbor cells by minimizing the SI in the small cell base station 21 will be described in detail with reference to FIG. 7.

The downlink receiver 52 of the small cell base station 21 may determine how much SI exists at step 701. For the determination, the control unit 521 of the downlink receiver 52 may control the downlink transmitting unit 512 to transmit a specific sequence (e.g., CAZAC, pseudo noise (PN) code, random sequence, etc.) to the downlink signal. The transmitted signal may be received by the downlink receiving unit 522 as well as other base stations. At this time, in addition to the measurement of the received signal strength (i.e., the interference amount), round trip delay (RTD) by a reflected wave may be measured, by which the radius of the cell of the small cell base station 21 can be estimated.

On the assumption that the downlink transmitting unit 512 uses the CAZAC code and orthogonal frequency division multiplexing (OFDM), both having enhanced autocorrelation properties, and that the downlink receiving unit 522 has a smaller transmission delay τ than the CP, a process of measuring the SI at step 701 is as follows.

If measurement of the SI is initiated, then the CAZAC code generating section 601 of the downlink transmitting unit 512 may generate the CAZAC codes as shown in equation 2.

$${C}_{M} ( n ) = exp [ - j \frac{π Mn ( n + 1 )}{{N}_{C}} ] , \\ n = 0 , 1 , … , {N}_{C} - 1 \qquad Eq . 2$$

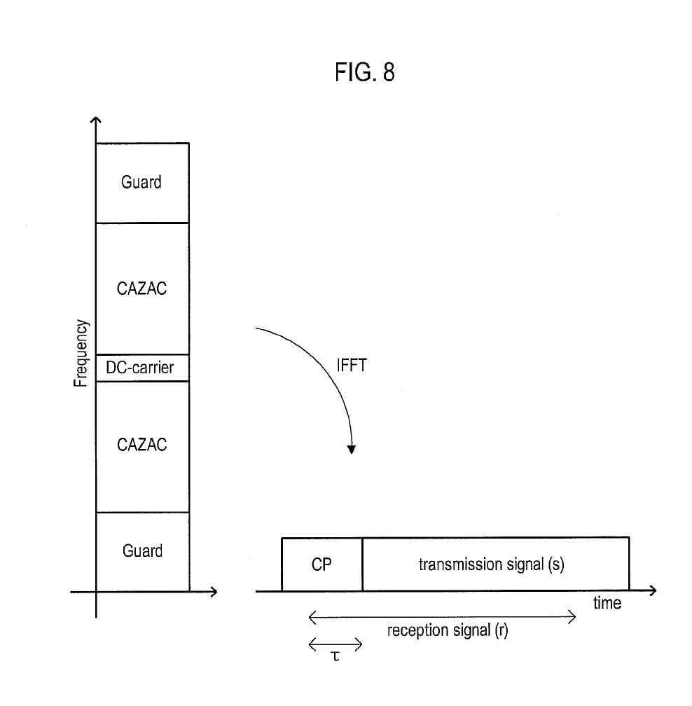

The subcarrier mapping section 602 may distribute the generated CAZAC codes over and under a DC-carrier such that the DC-carrier is interposed between the CAZAC codes, as shown in FIG. 8. In relation to the subcarrier spacing, there is no option but to adopt 7.5 kHz or 15 kHz subcarrier spacing in compliance with the LTE standard. The smaller the subcarrier spacing is, the longer the symbol timing becomes and the more accurate timing detection can be achieved. Thereafter, as shown in FIG. 8, the IFFT section 603 may execute the IFFT upon the signals mapped to the subcarriers to thereby transform the signals into time domain signals. The CP generating section 604 may generate and insert the CPs between the symbols to prevent occurrence of interference between the symbols. The transmission signals transformed into OFDM transmission symbols through the IFFT and the CP insertion may be transmitted via a transmission antenna.

The downlink receiving unit 522 may receive the transmission signals transmitted from the downlink transmitting unit 512, at which time signals delayed by the transmission delay τ are received. In one embodiment, to estimate the transmission delay τ, a correlator or a matched filter may be utilized. In another embodiment, the transmission delay can be estimated through the FFT, code compensation or IFFT.

The FFT processing section 611 of the downlink receiving unit 522 may remove the CPs, which were inserted to prevent the occurrence of interference between the symbols, from the received signals and carry out an FFT to transform the received signals into frequency domain signals. The FFT is carried out with respect to a section of the received signals, which contains some of the CPs therein, and the transformed signals include white noise w.

The subcarrier demapping section 612 may extract the CAZAC codes only from the received signals for which the FFT processing was performed.

The code compensating section 613 may multiply the demapped received signal by a conjugate complex number C*_{M}(n) in order to compensate the transmitted signal C_{M}(n). The conjugate complex number C*_{M}(n) can be defined as follows.

$${C}_{M}^{*} ( n ) = exp [ j \frac{π Mn ( n + 1 )}{{N}_{C}} ] , \\ n = 0 , 1 , … , {N}_{C} - 1 \qquad Eq . 3$$

The IFFT/IDFT processing section 614 may carry out the IFFT or IDFT on the signals for which the code compensation was performed, thereby detecting the received power and timing. The timing can be obtained by searching the highest of the signal strengths with the IFFT processing performed. Power around the signal having the highest strength is used as the received power.

The above-described SI measurement process of step 701 serves as the basic step for the next process, through which the control unit 521 may determine whether to apply restrictions to the downlink muting and the scheduling. If it is meant to unconditionally apply the restrictions by muting and scheduling while the sniffer apparatus (i.e., downlink receiver 52) is operating, the process of step 701 can be omitted. Specifically, even though the SI measurement process of step 701 is not performed, when the synchronization signals are measured to search the neighbor cells, the control unit 521 of the downlink receiver 52 may unconditionally mute (i.e., transmit with “zero” power) its synchronization signals (PSS/SSS) by controlling the downlink transmitting unit 512 (this is referred to as mute control). Further, the control unit 521 may allocate the PDSCH data not to the central six RBs but to the data channels of the other forty four RBs or, alternatively, allocate no PDSCH data to any of the RBs by controlling the scheduler 511 (this is referred to as first scheduling control (or restriction)). The mute control and the first scheduling control (or restriction) can be performed independently or together. The control unit 521 may not transmit PDSCH data to the central six RBs unconditionally by controlling the scheduler 511, when decoding the PBCH for acquisition of the RSRP/RSRQ information and broadcast information in order to search the neighbor cells (this is referred to as second scheduling control (or restriction)).

The above-described mute control process is assumed to be operated with respect to the radio frame with a length of 10 ms, which, however, can be varied depending on the synchronization signal reception method.

The above-described first scheduling control (or restriction) process may be operated with respect to the radio frame with a length of 10 ms. In other words, the first scheduling control (or restriction) process is to restrict the scheduling of the PDSCH data with respect to the central six RBs in the 10 ms radio frame.

The above-described second scheduling control (or restriction) process may be operated with respect to the subframe with a length of, for example, 1 ms. Further, the second scheduling control (or restriction) process may also include not performing the scheduling with respect to the whole band of the 1 ms subframe (i.e., all of the RBs in the 1 ms subframe), not with respect to the central six RBs. Furthermore, the second scheduling control (or restriction) process may also include not performing the scheduling with respect to the whole band (i.e., all of the RBs) of the 1 ms subframe when acquiring the PDSCH and PDCCH information of the neighbor cells and measuring the RSRP and RSRQ of the neighbor cells. As such, the second scheduling control (or restriction) process is to restrict the scheduling of the PDSCH data with respect to the central six RBs or all the RBs in the whole band in the 1 ms subframe.

To measure the synchronization signals of the neighbor cells, the downlink receiver 52 may perform sequence searching with respect to the frame length equal to or greater than about 5 ms, 10 ms or 20 ms via the downlink receiving unit 522 at step 703. In other words, by detecting the PSS of the radio signal, the PCI and slot synchronization may be obtained and, by detecting the SSS of the radio signal, the length of the CP, PCI group and frame synchronization may be obtained. At this time, if the SI measured in the SI measurement process of step 701 is equal to or greater than the threshold 1 (i.e., SI≧threshold 1) at step 702, the control unit 521 may control the downlink transmitting unit 512 to mute the PSS and SSS and then transmit the downlink (mute control process) at step 704. Along with or independently from the mute control process, to enhance the cell search performance, the control unit 521 may control the scheduler 511 not to perform the scheduling of the PDSCH data with respect to the central six RBs (first scheduling control (or restriction)) at step 704. Further, in the first scheduling control (or restriction) process, it is possible to allocate the PDSCH data to the data channels of the forty four RBs, not to the central six RBs, (as a result, the SI can be minimized due to the use of the different frequencies) or, alternatively, omit the PDSCH data allocation.

Herein, the threshold 1 is used as a criterion in the mute control and the first scheduling control (or restriction). Since the detection of the PSS and SSS can be facilitated by the threshold 1, a setting point of the threshold 1 may be when a signal to interference and noise ratio (SINR) of the synchronization signal (channel) reaches about −4 to −6 dB or more. Herein, it is to be noted that SINR=S/(I+N), wherein S denotes a signal strength of a target cell to be searched, I denotes the sum of the signal strength and SI power with respect to other cells and N denotes a noise power.

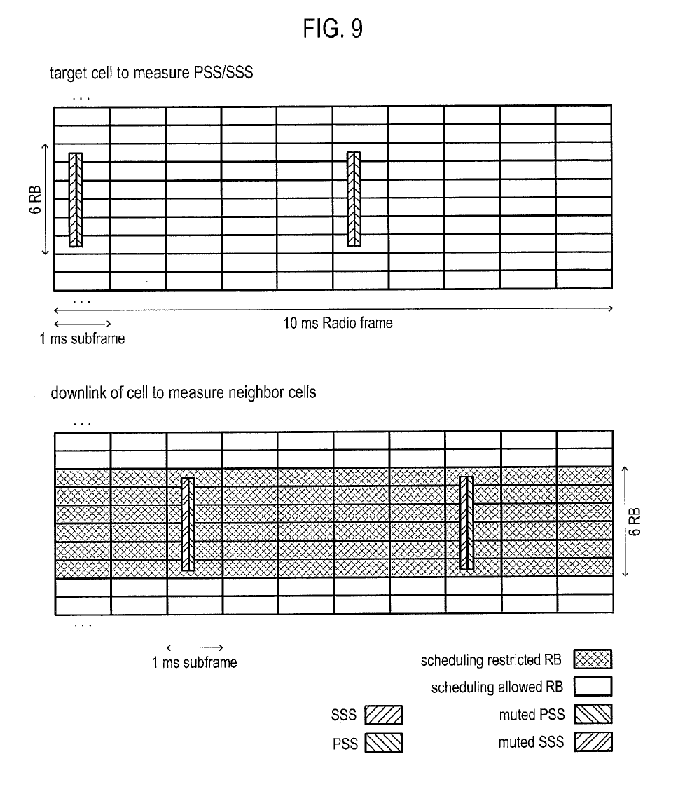

In measuring the synchronization signals for neighbor cell search, the processes of the mute control and the first scheduling control (or restriction) of the synchronization signals (PSS/SSS) are as shown in FIG. 9.

In the present embodiment, it is assumed that a radio frame with the length of 10 ms is used for detection of the PSS/SSS. In FIG. 9, the upper drawing is concerned with the neighbor cells and the lower drawing is concerned with the downlink of the base station causing SI. As shown in FIG. 9, the mute control of the PSS/SSS is performed with respect to the 10 ms radio frame. Together with or independently from the mute control, the scheduling restriction of not performing the scheduling with respect to the corresponding central six RBs is applied (the first scheduling control (or restriction)) to thereby avoid occurrence of SI (i.e., the PDSCH data are allocated to the data channels of the other RBs than the central six RBs, or none of the PDSCH data is allocated at all.) Herein, the muting of the PSS/SSS means making the power of the corresponding RBs “zero.”

As described above, the mute control and the first scheduling control (or restriction) can be operated together with or independently from each other.

To search the neighbor cells, the downlink receiver 52 may measure the RSRP/RSRQ and acquire the broadcast information through the PBCH decoding process at step 706. In this process, the RSRP may be measured by utilizing the synchronization and the PCI acquired through the process of step 703. The RSRP is necessary information for figuring out attenuation of paths to and from the neighbor base stations.

In the process of step 706, the information on the PBCH (channel including the MIB of the broadcast information), the PDSCH (channel including the SIB of the broadcast information) and the PDCCH (channel necessary for figuring out the PDSCH including the SIB of the broadcast information) is acquired, and the RSRP/RSRQ are measured.

In measuring the RSRP/RSRQ and acquiring the broadcast information, if SI is equal to or greater than a threshold 2 (i.e., SI≦threshold 2) at step 705, the control unit 521 may not perform the scheduling with respect to the subframes of the areas corresponding to the reference signal and the broadcast information in order to reduce SI, since the reference signal and the broadcast information operate by the 1 ms subframe (if the synchronization between the cells is not established, the length of the subframe section where the scheduling is not performed can be 2 ms) at step 707. In particular, since the PBCH is located at the central six RBs as are the PSS and SSS, the scheduling may not be performed with respect to at least the central six RBs in the section where the PBCHs of the neighbor cells are transmitted (the second scheduling control (or restriction) process). Further in the second scheduling control (or restriction) process, the scheduling may not be performed with respect to all of the RBs in the 1 ms subframe. Also in the second scheduling control (or restriction) process, when acquiring the PDSCH and PDCCH information and measuring the RSRP/RSRQ of the neighbor cell, the scheduling may not be performed with respect to all of the RBs in the 1 ms subframe since the PDSCH, PDCCH, and RSRP/RSRQ are spread over the whole band.

For reference, the broadcast information of the 3GPP LTE includes the MIB having a transmission cycle of 40 ms, the SIB type 1 having a transmission cycle of 80 ms, and the SIB types 2 to 11 of which transmission cycles can be designated freely.

In the following, the above described RSRP measurement process of step 706 will be described in more detail. A sequence pattern and location on the frequency of the RS varies depending on the PCI. Therefore, synchronization acquisition and PCI detection by using the PSS/SSS, and CP length estimation are essential to measure the RSRP. Through them, the location and the sequence pattern of the RS can be figured out. The RSRP can be measured by means of an interpolation estimator, an IFFT estimator, a least square (LS) estimator, a minimum mean squared error (MMSE) estimator or the like.

Also, the threshold 2 may be used as a criterion in the scheduling control (or restriction). Since the SINR of the RS should be about −4 dB or more, similarly to the case of the threshold 1, the setting point of the threshold 2 may be when it is determined that the SINR of the RS exceeds −4 dB by SI.

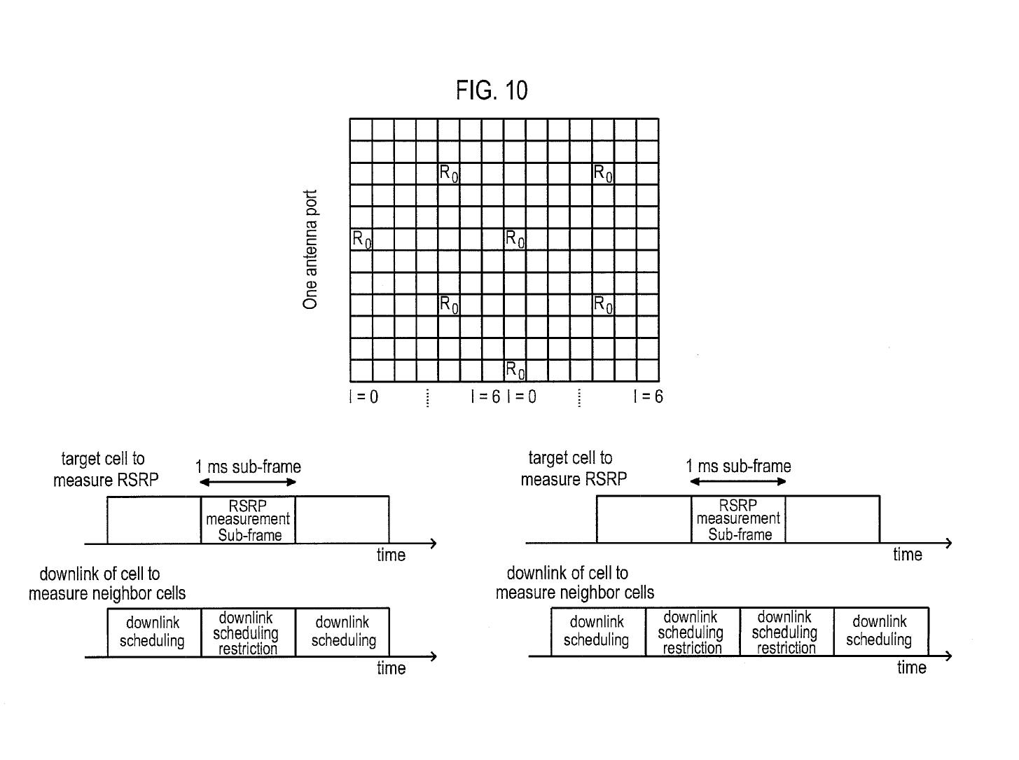

The above-described second scheduling control (or restriction) process of step 707 will be described in more detail below. Mapping of the RS with respect to the normal CP is as shown in FIG. 10. In FIG. 10, R₀ is a resource element (RE) where the RS is mapped and I is an OFDMA symbol index. I=0≠6 constitute one slot, and two slots constitute a 1 ms subframe (or TTI). If the downlink receiver 52 should measure the RSRP of the corresponding TTI (or subframe), the SINR of the RE including R₀ therein can be lowered by SI. In this case, if the synchronization has been established, scheduling restriction may be applied only to one subframe as shown in the drawings on the left side of FIG. 10. However, as shown in the drawings on the right side of FIG. 10, if the synchronization has not been established, two subframes should be subject to scheduling restriction. Here, the scheduling restriction means that the scheduling is not performed on the corresponding subframe. Specifically, the control unit 521 controls the downlink transmitting unit 512 not to transmit the PDSCH data. If the downlink receiving unit 522 receives the PBCH, the scheduling restriction is applied only to the central six RBs, since the PBCH is only mapped on the central six RBs.

In a storage medium in accordance with another embodiment, computer readable instructions for implementing the above-described embodiment are stored.

While the description has been made in the context of the LTE FDD system in the above embodiments, the present embodiments are equally applicable to a TDD system. Further, the present embodiments are applicable to not only the LTE system but also any other mobile communication systems in which the wireless layers are configured in the same manner as the LTE system (for example, an LTE-A system).

As used in this application, entities for executing the actions can refer to a computer-related entity, either hardware, a combination of hardware and software, software, or software in execution. For example, an entity for executing an action can be, but is not limited to being, a process running on a processor, a processor, an object, an executable, a thread of execution, a program, and a computer. By way of illustration, both an application running on an apparatus and the apparatus can be an entity. One or more entities can reside within a process and/or thread of execution and an entity can be localized on one apparatus and/or distributed between two or more apparatuses.

The program for realizing the functions can be recorded in the apparatus can be downloaded through a network to the apparatus and can be installed in the apparatus from a computer readable storage medium storing the program therein. A form of the computer readable storage medium can be any form as long as the computer readable storage medium can store programs and is readable by an apparatus such as a disk type ROM and a solid-state computer storage media. The functions obtained by installation or download in advance in this way can be realized in cooperation with an OS (Operating System) in the apparatus.

While certain embodiments have been described, these embodiments have been presented by way of example only, and are not intended to limit the scope of the disclosures. Indeed, the novel methods and systems described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. An apparatus for searching neighbor cells of a small cell base station, comprising:
a downlink receiver configured to measure first synchronization signals of neighbor base stations when searching neighbor cells having the same frequency band;
a downlink transmitter configured to perform at least one of a mute control and transmission of second synchronization signal of the small cell base station, and a scheduling restriction of physical downlink shared channel (PDSCH) data, when the downlink receiver measures the first synchronization signals.

2. The apparatus of claim 1, wherein the downlink receiver is configured to measure the amount of interference (self-interference (SI)) of the small cell base station and control at least one of muting and scheduling of the downlink transmitter based on the measurement result.

3. The apparatus of claim 2, wherein, in measuring the interference amount, a signal containing at least one of a constant amplitude zero auto correlation (CAZAC) code, a pseudorandom noise (PN) code, a random sequence is transmitted to a downlink via the downlink transmitter and the transmitted signal is received by the downlink receiver to thereby measure the interference amount of the received signal.

4. The apparatus of claim 3, wherein, in measuring the interference amount, round trip delay (RTD) is measured to thereby estimate the radius of a cell of the small cell base station.

5. The apparatus of claim 2, wherein the first synchronization signals are at least one of primary synchronization signals (PSSs) and second synchronization signal (SSSs) of neighbor base stations, and the second synchronization signal is at least one of the PSS and SSS of its base station.

6. The apparatus of claim 2, wherein, in controlling muting of the downlink transmitter, powers of the first and second synchronization signals allocated to a resource block (RB) in which the synchronization signals are transmitted are muted to zero.

7. The apparatus of claim 2, wherein, in controlling scheduling of the downlink transmitter, PDSCH data are allocated not to the RBs in which PDSCH is transmitted but to data channels of the other RBs or, alternatively, the PDSCH data are not allocated at all.

8. The apparatus of claim 2, wherein,
the downlink receiver is further configured to measure reference signal received power (RSRP) and reference signal received quality (RSRQ) of a reference signal (RS) and acquire broadcast information, through decoding of a physical broadcast channel (PBCH), when searching neighbor cells having the same frequency band; and
the downlink transmitter is further configured to transmit no PDSCH data to designated RBs of a subframe by restricting scheduling, when the downlink receiver acquires PBCH information.

9. An apparatus for searching neighbor cells of a small cell base station, comprising:
a downlink receiver configured to measure RSRP and RSRQ of an RS and acquire broadcast information, through decoding of a PBCH, when searching neighbor cells having the same frequency band; and
a downlink transmitter configured to transmit no PDSCH data to designated RBs of a subframe by restricting scheduling, when the downlink receiver acquires PBCH information.

10. The apparatus of claim 9, wherein, in controlling (restricting) the scheduling of the downlink transmitter, the PDSCH data are not transmitted to the RBs in which PDSCH is transmitted, when decoding the PBCH for acquisition of RSRP and RSRQ information and broadcast information to search neighbor cells.

11. The apparatus of claim 10, wherein the downlink transmitter is further configured to transmit no PDSCH data to all the RBs of a subframe by restricting scheduling, when the downlink receiver acquires information on a PDSCH and a physical downlink control channel (PDCCH) and measures RSRP and RSRQ.

12. The apparatus of claim 9, wherein,
the downlink receiver is further configured to measure first synchronization signals of neighbor base stations when searching neighbor cells having the same frequency; and
the downlink transmitter is further configured to perform at least one of a mute control and transmission of a second synchronization signal of the small cell base station, and a scheduling restriction of the PDSCH data, when the downlink receiver measures the first synchronization signals.

13. The apparatus of claim 12, wherein the first synchronization signals are at least one of primary synchronization signals (PSSs) and second synchronization signal (SSSs) of neighbor base stations, and the second synchronization signal is at least one of the PSS and SSS of its base station.

14. A method for searching neighbor cells of a small cell base station, comprising at least one of:
performing a mute control of a second synchronization signal of the small cell base station and transmitting the second synchronization signal with the mute control performed to a downlink; and
performing a downlink scheduling restriction of PDSCH data,
when a first synchronization signal is measured to search neighbor cells having the same frequency band.

15. The method of claim 14, further comprising transmitting no PDSCH data to designated RBs of a downlink subframe by restricting downlink scheduling, when acquiring PBCH information to search neighbor cells having the same frequency.

16. The method of claim 15, further comprising transmitting no PDSCH data to all the RBs of a downlink subframe by restricting downlink scheduling, when acquiring PDSCH and PDCCH information and measuring RSRP and RSRQ.

17. The method of claim 14, wherein,
the amount of interference (self-interference (SI)) of the small cell base station is measured when measuring the first synchronization signals; and
in measuring the interference amount, a signal containing at least one of a CAZAC code, PN code, a random sequence is transmitted to a downlink via the downlink transmitter, and the transmitted signal is received by the downlink receiver to thereby measure the interference amount of the received signal.

18. The method of claim 17, wherein round trip delay (RTD) is measured to thereby estimate the radius of a cell of the small cell base station.

19. The method of claim 14, wherein the first synchronization signals are at least one of primary synchronization signals (PSSs) and second synchronization signal (SSSs) of neighbor base stations, and the second synchronization signal is at least one of the PSS and SSS of its base station.
